(19) United States
(12) Patent Application Publication
(10) Pub. No.: US 2007/0183797 A1
(43) Pub. Date: Aug. 9, 2007

(54) Apparatus and method for protecting fixing unit from overheating and image forming apparatus using the same

(75) Inventor: Myeong-seok Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/505,373

(22) Filed: Aug. 17, 2006

(30) Foreign Application Priority Data
Feb. 8, 2006 (KR) 2006-12161

(51) Int. Cl. G03G 15/20

(52) U.S. Cl. 399/33; 399/69

(57) ABSTRACT

An apparatus and a method for protecting a fixing unit from overheating and to reduce a warm-up time of a fixing unit, and an image forming apparatus using the same are disclosed. According to aspects of the present invention, a temperature of the fixing unit is detected, the detected temperature and a first reference temperature are compared, and the temperature of the fixing unit is controlled based on results of the comparison while the controller is turned on and performs initialization. Once controller initialization is completed, the detected temperature is compared to a second reference temperature and an interrupt of the fixing unit heating power occurs when the detected temperature exceeds the second reference temperature.

### CROSS-REFERENCE TO RELATED APPLICATIONS

This application claims the benefit of Korean Application No. 2006-12161, filed Feb. 8, 2006, in the Korean Intellectual Property Office, the disclosure of which is incorporated herein by reference.

### BACKGROUND OF THE INVENTION

1. Field of the Invention

Aspects of the present invention relate to an apparatus and a method for protecting a fixing unit from overheating and an image forming apparatus using the same. More particularly, aspects of the present invention relate to an apparatus and a method for protecting a fixing unit from overheating to reduce a warm-up time, and an image forming apparatus using the same.

2. Description of the Related Art

An image forming apparatus includes a fixing unit to fix transferred toner on a paper using heat and pressure, and the fixing unit has to be regularly kept at a desired high temperature, but not overheated. To this end, an image forming apparatus has to include an apparatus to protect the fixing unit from overheating.

FIG. 1A is a block diagram showing the configuration of a conventional overheating protection apparatus.

Referring to FIG. 1A, the conventional overheating protection apparatus includes a sensor 101, a controller 103, and an overheating protector 105.

The controller 103 performs an initialization when the power Vcc of the image forming apparatus is turned on. During the initialization, the electrical potential of port A of the controller 103 hardwaredly prevents the electrical potential level from heating a fixing unit 107. Hardwaredly refers to use of physical circuitry as distinguished from use of software to accomplish a given task. Therefore, the fixing unit 107 is not heated while the controller 103 performs the initialization. After completing the initialization, the controller 103 compares the temperature of the fixing unit 107 detected by the sensor 101 to a target temperature (for example, a ready temperature T_{R} or a fixing temperature T_{F}), and changes the electrical potential level of port A to high or low according to the results of the comparison, so that the temperature of the fixing unit 107 can be controlled.

The overheating protector 105 compares the temperature of the fixing unit 107 detected by the sensor 101 to a reference set temperature, and interrupts the control operation of the controller 103 according to the results of the comparison. The reference set temperature is set to be higher than the target temperature, so that the overheating protector 105 can hardwaredly prevent overheating of the fixing unit 107 when the controller 103 cannot operate due to program errors or physical damage.

FIG. 1B is a graph showing temperature changes of the fixing unit controlled by the conventional overheating protector.

Referring to FIGS. 1A and 1B, the fixing unit 107 is not heated during the initialization of the controller 103, but the fixing unit 107 starts warming up by direction of the controller 103 after initialization is completed. If there is no printing order, the controller 103 can maintain the fixing unit 107 at the ready temperature T_{R}. Then again, the temperature of the fixing unit 107 may gradually rise at time t1 to reach T_{C}. This occurs when the controller 103 cannot control the temperature of the fixing unit 107 due to program errors or physical damage. In this case, if the temperature of the fixing unit 107 reaches a cut-off temperature T_{C}, the overheating protector 105 cuts off power supplied to the fixing unit 107 to protect the fixing unit 107.

As described above, in the conventional overheating protection apparatus, after the controller 103 performs the initialization, the fixing unit 107 warms up. As image forming apparatuses are made more intelligent and more multi-functional, initialization times of the controllers become longer. Accordingly, after a user turns on power, it takes more time to print a document.

### SUMMARY OF THE INVENTION

An aspect of the present invention is to solve the above and/or other problems and disadvantages and to provide the advantages described below and/or other advantages. Accordingly, an aspect of the present invention is to provide an apparatus and a method to protect a fixing unit from overheating and capable of reducing a warm-up time, and an image forming apparatus using the same.

In order to achieve the above-described and/or other aspects of the present invention, an overheating protection device of a fixing unit is provided comprising a sensor to detect a temperature of the fixing unit, a controller to control the temperature of the fixing unit, and an overheating protector to compare the temperature detected by the sensor to a first reference temperature, and to control the temperature of the fixing unit based on results of the comparison while the controller is turned on and performing an initialization.

According to an aspect of the present invention, after the initialization is completed, the overheating protector compares the temperature detected by the sensor and a second reference temperature, and when the detected temperature reaches the second reference temperature interrupts the control operation of the controller based on the results of the comparison.

According to an aspect of the present invention, the overheating protector receives a signal indicating completion of the initialization from the controller, and compares the detected temperature and the second reference temperature, in response to the signal.

According to an aspect of the present invention, the overheating protector comprises a reference temperature setting unit to select one of the first and second reference temperatures based on whether the initialization is completed, and a comparator to compare the reference temperature selected by the reference temperature setting unit and the detected temperature, and to output the results of the comparison.

According to an aspect of the present invention, the reference temperature setting unit comprises a power source, and a variable resistor connected to the power source to change a resistance based on whether the initialization is completed, and a voltage supplied to the variable resistor corresponds to one of the first and second reference temperatures.

According to an aspect of the present invention, the variable resistor comprises a first resistor having one end connected to the power source, and having other end connected to an input terminal of the comparator, a second resistor having one end connected to the other end of the first resistor, a third resistor having one end connected to the other end of the first resistor, and a transistor having one end connected to the other end of the third resistor, and which is turned on according to whether the initialization is completed, and a voltage supplied to the input terminal of the comparator that changes according to whether the transistor is turned on.

According to an aspect of the present invention, the first reference temperature is the temperature of the fixing unit on standby of printing.

In order to achieve the above-described and/or other aspects of the present invention, a method of protecting a fixing unit from overheating is provided comprising: detecting a temperature of the fixing unit, comparing the detected temperature and a first reference temperature in a first comparison operation, and controlling the temperature of the fixing unit based on results of the first comparison, while a controller to control the temperature of the fixing unit is turned on and performs an initialization.

While not required in all aspects, the method further comprises: comparing the detected temperature and a second reference temperature in a second comparison operation after the initialization is completed; and interrupting the control operation of the controller based on the results of the second comparison operation.

While not required in all aspects, the method further comprises: receiving a signal indicating completion of the initialization from the controller, wherein in the second comparison operation, the detected temperature and the second reference temperature are compared in response to receipt of the signal.

While not required in all aspects, the method further comprises: selecting one of the first and second reference temperatures based on whether the initialization is completed, to be used in the respective first and second comparison operations.

In order to achieve the above-described and/or other aspects or embodiments of the present invention, an image forming apparatus is provided comprising a fixing unit, a sensor to detect a temperature of the fixing unit, a controller to control the temperature of the fixing unit based on the detected temperature, and an overheating protector to compare the detected temperature to a first reference temperature, and control the temperature of the fixing unit based on results of the comparison while the controller is turned on and performs an initialization.

While not required in all aspects, after the initialization is complete, the overheating protector compares the temperature detected by the sensor and a second reference temperature, and interrupts the control operation of the controller based on the results of the comparison.

While not required in all aspects, the overheating protector receives a signal indicating completion of the initialization from the controller, and compares the detected temperature and the second reference temperature, in response to receipt of the signal.

While not required in all aspects, the overheating protector comprises a reference temperature setting unit to select one of the first and second reference temperatures based on whether the initialization is completed, and a comparator to compare the reference temperature selected by the reference temperature setting unit and the detected temperature, and to output results of the comparison.

While not required in all aspects, the reference temperature setting unit comprises a power source, and a variable resistor connected to the power source to change a resistance based on whether the controller initialization is completed, and a voltage supplied to the variable resistor to correspond to one of the first and second reference temperatures.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a block diagram showing the configuration of a conventional overheating protection apparatus;

FIG. 1B is a graph showing temperature changes of a fixing unit controlled by a conventional overheating protector;

FIG. 2 is a block diagram showing a configuration of an overheating protection apparatus of a fixing unit applied to an image forming apparatus according to an embodiment of the present invention;

FIG. 3 is a graph showing temperature changes of respective fixing units controlled by an overheating protection apparatus according to an embodiment of the present invention and a conventional overheating protection apparatus;

FIG. 4 is a graph showing temperature changes of respective fixing units controlled by an overheating protection apparatus according to an embodiment of the present invention and a conventional overheating protection apparatus; and

FIG. 5 is a flow chart showing an overheating protection method according to an embodiment of the present invention.

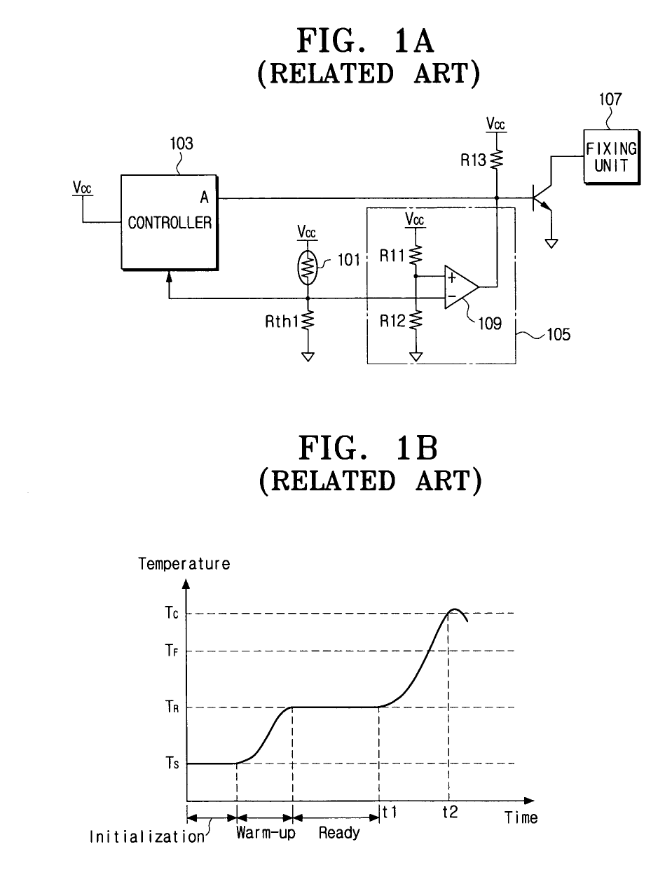

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

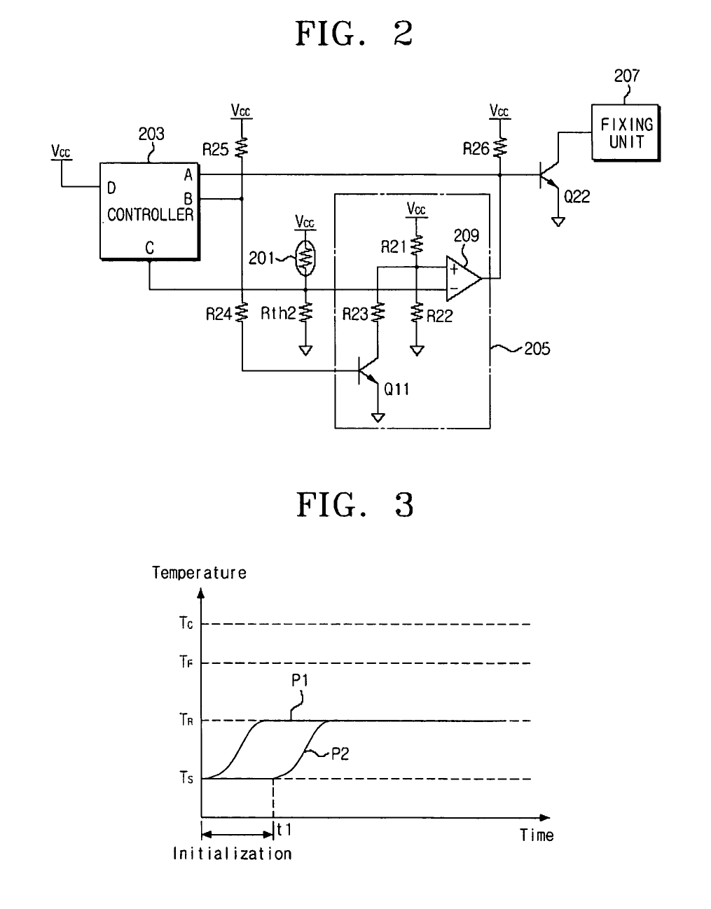

FIG. 2 is a block diagram showing a configuration of an overheating protection apparatus of a fixing unit applied to an image forming apparatus according to an embodiment of the present invention. Referring to FIG. 2, the overheating protection apparatus includes a sensor 201, a controller 203, and an overheating protector 205.

The sensor 201 detects a temperature of a fixing unit 207, and the controller 203 controls the temperature of the fixing unit 207 based on the detected temperature. The overheating protector 205 compares the detected temperature and a first reference temperature, and controls the temperature of the fixing unit 207 during an initialization of the controller 203 based on the results of the comparison. Although not required in all aspects, it is understood that the detecting and controlling of the temperature may be a continuous and ongoing operation during the initialization of the controller 203. The sensor 201 may detect the temperature of a heating roller (not shown) included in the fixing unit 207, and be thermally connected to the heating roller. “Thermally connected” refers to the sensor 201 being located in a place where the sensor 201 can detect heat generated from the heating roller. For example, a thermistor having a negative resistance-temperature characteristic (NTC) or a thermocouple can be used as a sensor 201, such that the resistance value of the thermistor or thermocouple changes according to the temperature. Other embodiments of a sensor 201 to detect the temperature of the fixing unit 207 heater roller, include an infrared detector, a semiconductor bandgap temperature sensor or a shape memory alloy.

The controller 203 controls the temperature of the fixing unit 207 based on the temperature detected by the sensor 201. After being turned on, the controller 203 performs the initialization and then controls the temperature of the fixing unit 207. While performing the initialization, however, the controller 203 cannot control the temperature of the fixing unit 207. After completing the initialization, the controller 203 can control the temperature of the fixing unit 207. The “initialization” refers to the operation to reach a state where the controller 207 can perform its intended function. The initialization can include, for example, loading a control program into a memory, releasing compression of a code, and/or initializing each port.

After completing the initialization, the controller 203 may output a signal showing the initialization is completed (hereinafter, referred to as an “initialization completion signal”). For example, the controller 203 changes the electrical potential of port B after completing the initialization. According to the embodiment of FIG. 2, the controller 203 changes the electrical potential of port B to a low level E_{BL} after completing the initialization. As described later, when the electrical potential of port B is at a low level E_{BL}, a transistor Q11 is not turned off.

According to whether the initialization is completed, the characteristics of the electrical potential of port A and port B are as follows:

TABLE 1

| | | Power “ON” | |
|---|---|---|---|
| | | During | After |
| Power “OFF” | | initialization | initialization |
| Port A | Unknown | High level E_{AH} | High E_{AH} or low level E_{AL} |
| Port B | Unknown | High level E_{BH} | Low level E_{BL} |

While power is “ON” and the initialization is underway, the controller 203 cannot control the temperature of the fixing unit 207, and the overheating protector 205 controls the temperature of the fixing unit 207. In the mean time, while the initialization is underway, port B of the controller 203 stays at a high level E_{BH}, and port B hardwaredly stays at the high level E_{BH} regardless of the initialization of the controller 203. When port B is at the high level E_{BH}, the transistor Q11 is turned on. As described later, if the transistor Q11 is turned on, the overheating protector 205 compares the first reference temperature to the temperature detected by the sensor 201.

In this specification, “ON or OFF” refers to whether a power source, which supplies electric power to an image forming apparatus employing an overheating protection apparatus according to an embodiment of the present invention, is turned on or off, or whether a power source which supplies electric power to only a particular component, for example the fixing unit 207, of the image forming apparatus is turned on or off. Additionally, the reference to a “high” level or “low” level of the electrical potential in this specification depends on, for example, whether the transistors Q11 or Q22 can be turned on. That is, the electrical potential of a high level in port B E_{BH} is the electrical potential of a level capable of turning on the transistor Q11, and the electrical potential of a low level in port B E_{BL} is the electrical potential below the level capable of turning on the transistor Q11. Likewise, the electrical potential of a high level in port A E_{AH} is the electrical potential of a level capable of turning on transistor Q22, and the electrical potential of a low level in port A E_{AL} is the electrical potential of a level not capable of turning on transistor Q22. Accordingly, the absolute value of the electrical potential of a high level in port A E_{AH}, and the absolute value of the electrical potential of a high level in port B E_{BH} can be different.

The operation of the controller 203 after the initialization will now be described. In this case, the controller 203 changes the electrical potential of port B to a low level E_{BL}. Additionally, the controller 203 controls the fixing temperature of the fixing unit 207 based on the temperature detected by the sensor 201. As in FIG. 2, the controller 203 changes the electrical potential of port A to a low level E_{AL} or high level E_{AH} in order to control the fixing temperature of the fixing unit 207. If port A is changed to a high level E_{AH}, transistor Q22 is turned on and electric power for heating is supplied to the fixing unit 207. If port A is changed to a low level E_{AL}, transistor Q22 is turned off and electric power to the fixing unit 207 is blocked.

Port C of the controller 203 receives the temperature information detected by the sensor 201, and specifically receives an electrical signal corresponding to the measured temperature. The controller 203 can include an analog-to-digital (A/D) converter (not shown) to convert an analog signal input through port C to a digital signal. The controller 203 compares the temperature detected by the sensor 201 (more specifically, a value converted by the A/D converter) to a target temperature, and changes the electrical potential of port A to the low level E_{AL} or high level E_{AH} based on the results of the comparison. The target temperature can be, for example, a ready temperature or a fixing temperature. The ready temperature is the temperature of the fixing unit 207 while waiting for printing, and the fixing temperature is the temperature of the fixing unit 207 while performing printing.

The overheating protector 205 includes a reference temperature setting unit to select one of the first or second reference temperatures and a comparator 209. According to the present embodiment shown in FIG. 2, the reference temperature unit includes components Q11, R21, R22, R23, and VCC. The reference temperature setting unit components Q11, R21, R22, R23, and VCC select one of the first or the second reference temperatures, based on whether the controller 203 has completed the initialization. The comparator 209 compares the reference temperature selected by the reference temperature setting unit to the temperature detected by the sensor 201, and outputs the result of the comparison. The comparator 209 outputs a signal of a low level E_{DL}, if the temperature detected by the sensor 201 is over the reference temperature.

The reference temperature setting unit includes the power source unit VCC and the variable resistance components Q11, R21, R22 and R23. The variable resistance components in this instance are a transistor Q11 and resistors R21, R22 and R23. The voltage supplied to the variable resistance components Q11, R21, R22 and R23 corresponds to the first or second reference temperature, and the resistance value of the variable resistance changes according to whether the controller 203 has completed the initialization.

The first reference temperature can be, for example, in a range of 100° C.-120° C., and the second reference temperature can be, for example, in a range of 220° C.-230° C.

As in FIG. 2, the variable resistance components include a resistor R21 having one end connected to the power source unit VCC, and having the other end connected to an input port of the comparator 209, a resistor R22 having one end connected to the other end of the resistor R21, a resistor R23 having one end connected to the resistor R21, and the transistor Q11 having one end connected to the resistor R23, and which is turned on according to whether the controller 203 has completed the initialization. When the transistor Q11 is turned on, the voltage supplied to a non-inverting port of the comparator 209 is lowered. If the transistor Q11 is turned off, the resistor R23 is ignored and the voltage supplied to the non-inverting port of the comparator 209 is higher. In this embodiment, when the transistor Q11 is turned on, the lower voltage supplied to the non-inverting port corresponds to the first reference temperature, and when the transistor Q11 is turned off, the higher voltage supplied to the non-inverting port corresponds to the second reference temperature.

In the comparator 209, the non-inverting port receives an electrical signal (for example, the electrical potential) corresponding to the reference temperature set by the reference temperature setting unit components Q11, R21, R22, R23, and VCC, and the inverting port receives an electrical signal corresponding to the temperature detected by the sensor 201, so that a result of the comparison between the values is output. For example, the comparator 209 can output a low-level signal E_{DL} if the detected temperature is higher than the reference temperature.

The overheating protector 205 according to an embodiment of the present invention has two operation modes. The first operation mode is to control the temperature of the fixing unit 207 while the controller 203 performs the initialization, and the second operation mode is to interrupt control of the fixing unit 207 by the controller 203 after the controller 203 completes the initialization.

In the first operation mode, the overheating protector 205 compares the temperature detected by the sensor 201 to the first reference temperature, and controls the temperature of the fixing unit 207 based on the results of the comparison. When the overheating protector 205 is in the first operation mode, the controller 203 cannot control the temperature of the fixing unit 207 as described above.

In the second operation mode, the overheating protector 205 compares the temperature detected by the sensor 201 to the second reference temperature, and interrupts operation control of the controller 203 based on the results of the comparison. As shown in FIG. 2, whether to turn on or off a switch Q22 is determined according to the electrical potential E_{DL}/E_{DH} of the output terminal of the comparator 209 regardless of whether the electrical potential of port A of the controller 203 is at the high level E_{AH} or low level E_{AL}.

According to an embodiment of the present invention, the second reference temperature is higher than the target temperature of the controller 203. Therefore, during normal operation when the controller 203 operates without errors, the temperature of the fixing unit 207 cannot rise over the target temperature, so the output of the comparator 209 stays at the high level E_{DH}. However, due to program errors or physical damage of the controller 203, port A might stay at the high level E_{AH} of the electrical potential. In this case, when the temperature detected by the sensor 201 is higher than the second reference temperature, the overheating protector 205 can hardwaredly cut off the rise of the temperature of the fixing unit 207 as shown in FIG. 2.

FIG. 3 is a graph showing temperature changes of a fixing unit controlled by an overheating protection apparatus according to an aspect of the present invention and a fixing unit controlled by a conventional overheating protection apparatus, respectively.

Referring to FIG. 3, graph P1 shows temperature change of the fixing unit 207 controlled by the overheating protection apparatus according to an aspect of the present invention, and graph P2 shows temperature change of the fixing unit controlled by a conventional overheating protection apparatus. In FIG. 3, T_{S} is the starting temperature, T_{F} is the ready temperature, T_{F} is the fixing temperature, and T_{C} is the cutoff temperature.

Referring to graph P1, the operation of the overheating protection apparatus according to an aspect of the present invention will be described. Right after the power is turned on, the temperature of the fixing unit 207 is controlled. That is, the fixing unit 207 can reach the ready temperature before reaching time t1 when the initialization of the controller 203 is completed. As described above, this is because the overheating protector operates in the first operation mode after the power is turned on until the controller 203 initialization is completed.

Meanwhile, graph P1 shows an example in which the first reference temperature is set as the ready temperature. Alternatively, the first reference temperature can be set to be lower or higher than the ready temperature. When the first reference temperature is set to be lower than the ready temperature, graph P1 in the initialization section can stabilize before reaching the ready temperature.

Referring to graph P2, when the power is turned on, the temperature of the fixing unit 207 starts being controlled after the time t1 when the initialization is completed. As shown in graphs P1 and P2, the temperature of the fixing unit 207 in the overheating protection apparatus according to an aspect of the present invention can more rapidly reach the ready temperature T_{R}, compared to the temperature in the conventional overheating protection apparatus. Accordingly, warm-up time can be reduced.

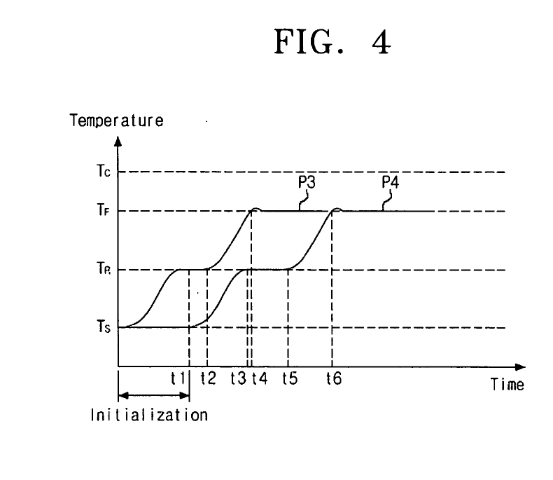

FIG. 4 is a graph showing temperature changes P3 and P4 of fixing units controlled by an overheating protection apparatus according to an aspect of the present invention and a conventional overheating protection apparatus, respectively.

Referring to FIG. 4, graph P3 shows a temperature change of the fixing unit 207 controlled by the overheating protection apparatus according to an aspect of the present invention, and graph P4 shows a temperature change of a fixing unit controlled by a conventional overheating protection apparatus.

Referring to graph P3, the operation of the overheating protection apparatus according to an aspect of the present invention will be described. Right after the power is turned on, the temperature of the fixing unit 207 rises. The fixing unit 207 reaches the ready temperature T_{R} before the initialization of the controller is completed. Therefore, the image forming apparatus equipped with the overheating protection apparatus according to an aspect of the present invention can perform the operation corresponding to a printing command anytime after the power is turned on and the initialization is completed. It is assumed that the printing command is received at time t2 in graph P3. The controller 203 controls the temperature of the fixing unit 207 after t2 to raise the temperature to the fixing temperature T_{F}. Meanwhile, the overheating protector according to an aspect of the present invention operates in the second operation mode after time t1.

Referring to graph P4, after the time t1 when the initialization of the controller 103 is completed, the fixing unit 107 is heated to reach the ready temperature T_{R} at time t3. Accordingly, the image forming apparatus equipped with the conventional overheating protection apparatus cannot perform the operation corresponding to a printing command, until after the power is turned on and the temperature reaches the ready temperature at t3. It is assumed that the printing command is received at time t5 in graph P4. The controller 103 controls the temperature of the fixing unit 107 after t5 to raise the temperature to the fixing temperature T_{F} (where t1<t2<t3<t4<t5).

As shown in FIGS. 3 and 4, as the fixing unit according to aspects of the present invention rapidly reaches the ready temperature, the fixing unit can perform the fixing operation more quickly after the power is turned on than the conventional apparatus.

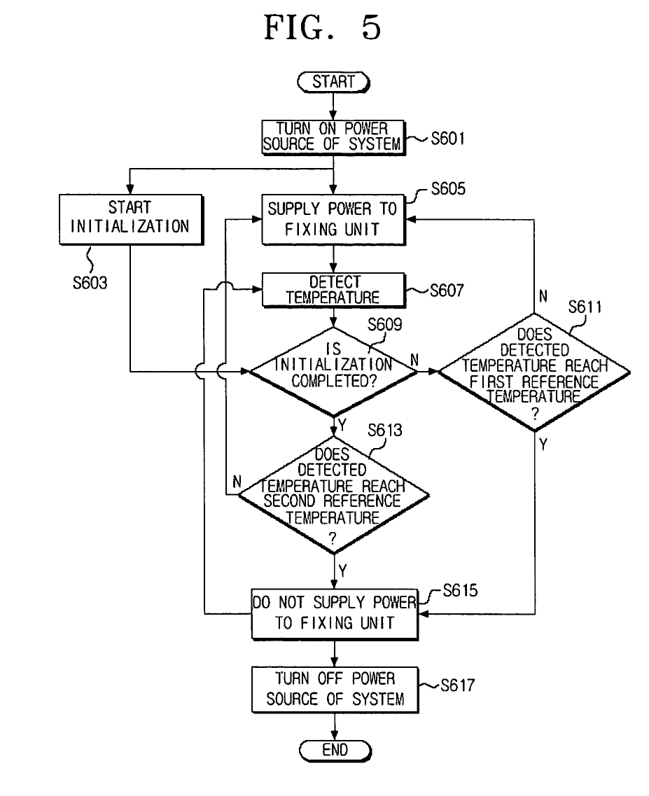

FIG. 5 is a flow chart showing an overheating protection method according to an embodiment of the present invention.

When the power source of a system to supply power to the image forming apparatus is turned on (S601), the controller 203 performs the initialization (S603), and the overheating protector 205 controls to supply power to the fixing unit 207 (S605). In the operation S603, ports A and B of the controller 203 keep the electrical potential at a high level, E_{AH} and E_{BH}, respectively. Keeping the electrical potential at a high level at ports A and B is hardwaredly performed when the power source of the system is turned on as in FIG. 2, regardless of whether the controller 203 completes the initialization.

The sensor 201 detects the temperature of the fixing unit 207 (S607). When the initialization of the controller 203 is not completed (S609: N), the overheating protector 205 compares the first reference temperature to the temperature detected in operation S607 (S611) to control the temperature of the fixing unit 207 (S615 or S605). Meanwhile, the temperature detection of the sensor 201 in operation S607 may be performed continuously or discontinuously, or periodically or non-periodically from the point when the power source of the system is turned on (S601) until the point when the power source of the system is turned off (S617).

When the detected temperature is higher than the first reference temperature (S611: Y), the overheating protector 205 cuts off the power supply to the fixing unit 207 (S615). If the detected temperature is lower than the first reference temperature (S611: N), operations S605, S606, and S609 are performed again.

When the initialization is completed, the controller 203 compares the temperature detected in operation S607 to the target temperature (for example, the ready temperature or printing temperature) to control the temperature of the fixing unit 207. When the initialization of the controller 203 is completed (S609: Y), the overheating protector 205 compares the second reference temperature and the temperature detected in operation S605 (S613), and interrupts the controller 203 control operation of the fixing unit 207 according to the results of the comparison.

After operation S615, until the power of the system is turned off (S617), operations S607, S609, S611, S613, S615 and S605 are repeated.

In the above embodiment, the controller 203 can be implemented by a part of functions of an engine controller generally equipped in an image forming apparatus, or a separate function block. In addition, the variable resistance components Q11, R21, R22 and R23 in the above embodiment are 3 resistance elements and a transistor, but can be implemented in other configurations. The variable resistance used in the overheating protector 205 according to an aspect of the present invention can be configured in any way to change the resistance value according to whether the initialization of the controller 203 is completed.

Meanwhile, the power sources Vcc used in aspects of the present invention can be utilized commonly, by group or separately, and the sensor 201 may be an analog sensor or digital sensor. In the case of the digital sensor, an A/D converter is not necessarily required.

As described above, the temperature of the fixing unit is controlled simultaneously with the initialization of the controller so that the warm-up time of the fixing unit is shortened.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An overheating protection device of a fixing unit, comprising:
a sensor to detect a temperature of the fixing unit;
a controller to control the temperature of the fixing unit; and
an overheating protector to compare the temperature detected by the sensor and a first reference temperature, and to control the temperature of the fixing unit based on results of the comparison while the controller is turned on and performs initialization.

2. The overheating protection device of claim 1, wherein the overheating protector compares the temperature detected by the sensor and a second reference temperature, and interrupts the control operation of the controller based on results of the comparison after the initialization is completed.

3. The overheating protection device of claim 2, wherein the overheating protector receives a signal from the controller to indicate completion of the controller initialization, and the overheating protector compares the detected temperature and the second reference temperature, in response to the signal.

4. The overheating protection device of claim 2, wherein the overheating protector comprises:
a reference temperature setting unit to set one of the first and second reference temperatures based on whether the controller initialization is completed; and
a comparator to compare the reference temperature set by the reference temperature setting unit and the detected temperature, and to output results of the comparison.

5. The overheating protection device of claim 4, wherein the reference temperature setting unit comprises:
a power source; and
a variable resistance connected to the power source to change a resistance based on whether the controller initialization is completed, and a voltage supplied to the variable resistance corresponds to one of the first and second reference temperatures.

6. The overheating protection device of claim 5, wherein the variable resistance comprises:
a first resistor with one end connected to the power, and other end connected to an input terminal of the comparator;
a second resistor with one end connected to the other end of the first resistor;
a third resistor with one end connected to the other end of the first resistor; and
a transistor with one end connected to the other end of the third resistor, and the transistor is turned on according to whether the controller initialization is completed, and a voltage supplied to the input terminal of the comparator changes according to whether the transistor is turned on.

7. The overheating protection device of claim 1, wherein the first reference temperature is the temperature of the fixing unit on standby of printing.

8. The overheating protection device of claim 1, wherein the sensor comprises an analog-to-digital converter.

9. The overheating protection device of claim 1, wherein the sensor comprises one from the group of: a thermistor, a thermistor having a negative resistance-temperature characteristic, a thermocouple, an infrared detector, a shape memory alloy, a semiconductor bandgap temperature sensor, and a combination thereof.

10. A method of protecting a fixing unit from overheating, comprising:
detecting a temperature of the fixing unit;
comparing the detected temperature to a first reference temperature; and
controlling the temperature of the fixing unit based on results of the comparison, while a controller to control the temperature of the fixing unit is turned on and performs initialization.

11. The method of claim 10, further comprising:
comparing the detected temperature to a second reference temperature; and
interrupting the control operation of the controller based on the results of comparing the detected temperature to the second reference temperature, after the initialization is completed.

12. The method of claim 11, further comprising:
receiving a signal indicating completion of the controller initialization from the controller, and
wherein in the comparing the detected temperature to the second reference temperature, the detected temperature and the second reference temperature are compared in response to the signal.

13. The method of claim 11, further comprising:
setting one of the first and second reference temperatures based on whether the controller initialization is completed, and
wherein the reference temperature set based on whether the controller initialization is completed is used in one of comparing the detected temperature to the first reference temperature or comparing the detected temperature to the second reference temperature.

14. An image forming apparatus, comprising:
a fixing unit;
a sensor to detect a temperature of the fixing unit;
a controller to control the temperature of the fixing unit based on the detected temperature; and
an overheating protector to compare the detected temperature with a first reference temperature, and to control the temperature of the fixing unit based on results of the comparison while the controller is turned on and performs initialization.

15. The image forming apparatus of claim 14, wherein the overheating protector compares the temperature detected by the sensor and a second reference temperature, and interrupts the control operation of the controller based on results of the comparison after the controller initialization is completed.

16. The image forming apparatus of claim 15, wherein the overheating protector receives a signal to indicate completion of the controller initialization from the controller, and compares the detected temperature and the second reference temperature, in response to the signal.

17. The image forming apparatus of claim 15, wherein the overheating protector comprises a reference temperature setting unit to set one of the first and second reference temperatures based on whether the controller initialization is completed; and
a comparator to compare the reference temperature set by the reference temperature setting unit and the detected temperature, and to output the results of the comparison.

18. The image forming apparatus of claim 17, wherein the reference temperature setting unit comprises:
a power source; and
a variable resistance connected to the power source to change a resistance based on whether the controller initialization is completed, and a voltage supplied to the variable resistance corresponds to one of the first and second reference temperatures.

19. An overheating protection device of a fixing unit, comprising:
a controller to control the temperature of the fixing unit;
a power source to supply power to the fixing unit heater during a controller initialization period; and
a feed-back loop to interrupt the power source when the fixing unit reaches a first reference temperature.

20. The overheating protection device of claim 19, wherein at the end of the controller initialization period the feed-back loop interrupts the controller control of the fixing unit when the fixing unit reaches a second reference temperature.

21. The overheating protection device of claim 20, wherein
the first reference temperature is the temperature of the fixing unit on standby of printing; and
the second reference temperature is higher than the first reference temperature and higher than an operating temperature of the fixing unit.

22. A method of protecting a fixing unit from overheating, comprising:
hardwaredly heating the fixing unit to a ready temperature during a controller initiation period.

23. The method of protecting a fixing unit from overheating of claim 22, further comprising:
interrupting the control operation of the controller when the fixing unit temperature reaches a cut-off temperature after the controller initialization is completed.
